(19) United States
(12) Patent Application Publication
(10) Pub. No.: US 2009/0203368 A1
(43) Pub. Date: Aug. 13, 2009

(54) AUTOMATED RECORDING OF VIRTUAL DEVICE INTERFACE

(75) Inventors: David John Marsyla, Belmont, CA (US); Faraz Ali Syed, Dublin, CA (US); John Tupper Brody, Belmont, CA (US); Jeffrey Allard Mathison, Pacifica, CA (US)

Correspondence Address: MORRISON & FOERSTER, LLP, 555 WEST FIFTH STREET, SUITE 3500, LOS ANGELES, CA, 90013-1024, US

(73) Assignee: Mobile Complete, Inc., San Mateo, CA (US)

(21) Appl. No.: 12/029,445

(22) Filed: Feb. 11, 2008

(51) Int. Cl. H04M 3/00

(52) U.S. Cl. 455/418

(57) ABSTRACT

The present invention provides a means for automated interaction with a Mobile Device to create a graph of the menu system, Mobile Applications, and Mobile Services available on the Mobile Device. The information recorded in the graph can then be played back interactively at a later time. In order to build a graph in this automated fashion, the physical Mobile Device is integrated with a Recording/Control Environment. This environment has a Device Interface, which has the ability to control the user interface of the Mobile Device and record the resulting video and audio data from the Device. An automation Crawler uses the Device Interface to navigate the Mobile Device to unmapped states. A State Listener monitors the data coming to and from the Mobile Device and resolves it to a single state, saving new states to the graph as needed.

### FIELD OF THE INVENTION

This invention relates to an interactive virtual mobile device emulator that can provide a user with an extensive and representative experience of the features available for a particular mobile device.

### BACKGROUND OF THE INVENTION

A large variety of mobile information processing devices (“Mobile Devices”) are produced each year. Consumers of Mobile Devices are faced with a variety of choices when purchasing a device, and more than 70% of all consumers do some sort of research on the Internet before making a purchase, and roughly 15% of all consumers actually purchase a Mobile Device from the Internet.

Previously, only general information has been available about the functionality of a Mobile Device itself, its wireless data services (“Mobile Services”), and downloadable applications (“Mobile Applications”). This information has generally consisted of device specifications such as display size, memory size, wireless network compatibility, and battery life information.

As Mobile Devices, Mobile Services, and Mobile Applications become more sophisticated, there is a need to provide a more extensive and interactive preview of the device and services available for consumers. Previously, attempts have been made to show mobile products and services using visual demonstrations created with standard authoring tools such as HTML or Adobe Flash, but these generally provide a limited and non-interactive representation of the actual functionality being offered. These representations are limited by the nature of how they are created, generally by taking still photographs of a Mobile Device LCD display and piecing these individual frames together into a mock-up of the actual application or service. Also, since the demonstrations must be created in advance, it has not been possible to make them interactive in any way that is similar to the actual experience of the application on the live Mobile Device.

Therefore, there is a need for a more sophisticated method of creating interactive virtual Mobile Device emulators (“Virtual Devices”) that can be experienced in a way that is much more extensive and representative of the features available for a particular Mobile Device.

### SUMMARY OF THE INVENTION

One way to create an interactive emulator is to manually navigate a physical Mobile Device while a system captures output from the device in the form of images, sounds, and hardware states, and connects them together based on the actions that the human user performed to cause them. This approach can be tedious and may require the human user to have detailed knowledge of the system capturing Mobile Device output in order to use it effectively. An improvement on this approach is to replace the human user with an automaton that navigates the Mobile Device by invoking user input such as key presses, touch screen touches, sound inputs, etc. This allows a more systematic approach to navigating the Mobile Device, as the automaton can keep track of all paths previously navigated and can interact with the capturing system to determine the most efficient path for navigating new paths on the Mobile Device.

The present invention provides a means for automated interaction with a Mobile Device with the goal of creating a map, or graph, of the structure of the menu system, Mobile Applications, and Mobile Services available on the Mobile Device. The information recorded in the graph can then be played back interactively at a later time.

In order to build a graph in this automated fashion, the physical Mobile Device is integrated with a recording and control environment (“Recording/Control Environment”). This environment has an interface (“Device Interface”), which has the ability to control the buttons or touch screen interface of the Mobile Device and record the resulting video and audio data that is produced. There are several ways to implement the Device Interface, including installing a software agent on the Mobile Device, building a mechanical harness, or making direct electrical connections into the hardware of the Mobile Device.

After the graph of the Mobile Device has been generated through this automated control-and-record process, it can be presented to a user in a way that allows them to navigate through the various screens of a Mobile Device without interacting with the physical Mobile Device itself. Instead, data that was captured from the Mobile Device and stored on a central server is sent back to the user and displayed as it would be seen on the real Mobile Device. In this way, a single physical Mobile Device can be virtualized and displayed to many users in concurrent, interactive sessions.

During the process of building the graph for a Mobile Device, each page that is available in the menu structure of the Mobile Device's user interface can be represented as a state in a large multi-directional graph. Each state (or page) of the graph is connected to other states in the graph by links representing the means used to navigate between the two pages. For example, if the home page of the Mobile Device user interface is represented by a state in the graph labeled “Home” and the menu of applications on the Mobile Device is represented by another state on the graph labeled “Menu,” then the key that is used to navigate between the two pages would form a link between the states of the graph.

In the Recording/Control Environment, an automation engine (“Crawler”) uses the Device Interface to manipulate the state of the Mobile Device, while a listener (“State Listener”) monitors the data coming to and from the Mobile Device via the Device Interface and resolves it to a single state, saving new states to the graph as needed. The State Listener listens to outgoing data from the Device Interface such as screen images, sounds, vibration state, or other physical events from the Mobile Device and compares them to known existing states. The State Listener listens to incoming data to the Device Interface such as key presses, touch screen events, audio input, etc. to link the previous state in the Mobile Device's graph with the current state. If the State Listener does not recognize a sequence of outgoing data as an existing saved state, it creates a new state in the graph with that sequence of data.

In order for the Crawler to begin navigation of the Mobile Device, it is configured with a known sequence of inputs that will put the Mobile Device in a known state (“Root”), and a way of recognizing that state. After the Crawler has navigated to the known state on the Mobile Device, it can repeatedly send sequences of inputs to the Mobile Device, while the State Listener builds a graph consisting of the resulting states. As the graph is being built, the Crawler iteratively finds the state that is the smallest number of links away from the Root and does not have outgoing links for all possible device inputs, and then sends one of those inputs before returning to the Root. This builds the graph of the Mobile Device in a breadth-first manner, although other algorithms could be employed, including depth-first, iteratively deepening depth-first, or heuristic approaches.

The complexity of most Mobile Devices makes it practically impossible to navigate to every unique state on the Mobile Device, so the Crawler can be configured to avoid navigating beyond certain states by identifying those states with a means of comparison and a list of allowed or restricted inputs (“Limit Conditions”). This allows the Crawler to spend more time navigating through states relevant to the user experience of the Mobile Device, and less time sending random input that is of little relevance, for example free-form text or numeric entry.

Finally, there may be some screens that an automated Crawler is not likely to reach when building a graph of the Mobile Device, particularly those that require specific non-random inputs such as text or numeric entry to reach them. Nevertheless, these screens may be of interest to someone using the Virtual Device in the run-time environment based on the graph. Therefore, the Recording/Control Environment allows for manual control of the Mobile Device in two modes. In both modes, the Crawler is disabled but the Device Interface and State Listener components remain active. In one mode, the user building the graph navigates the Mobile Device with the State Listener capturing each screen and key press, the same as if the Crawler were navigating. In the other mode, the user building the graph can capture a single video, which may consist of many states in sequence, and associate this video to a single node in the graph with a special type (“Endpoint Video”). This type of node demonstrates functionality beyond the edge of the freely navigable portion of the graph, showing one specific sequence of user input on the Virtual Device that is meant to be representative of how one might use the physical Mobile Device. Examples are dialing a phone number, entering and sending an SMS message, or taking live photos and video with the Mobile Device, though this model can apply to almost any complex use case a Mobile Device might support.

### BRIEF DESCRIPTION OF THE DRAWINGS

FIG. 1 illustrates an exemplary system block diagram employing an automated menu system map generation system according to embodiments of the invention.

FIG. 2 illustrates an exemplary flow diagram of an exemplary state listener process according to embodiments of the invention.

FIG. 3 illustrates an exemplary block diagram of exemplary audio/video processing logic within the State Listener according to embodiments of the invention.

FIG. 4 illustrates an exemplary audio/video buffer format as used by the State Listener according to embodiments of the invention.

FIG. 5 illustrates an exemplary functional block diagram of dynamic content masking logic as used by the State Listener according to embodiments of the invention.

FIG. 6 is an illustration of an exemplary Mask Configuration Tool used for dynamic content masking by the State Listener according to embodiments of the invention.

FIG. 7 illustrates exemplary Audio/Video Processing Data Structures as used in by the State Listener according to embodiments of the invention.

FIG. 8 illustrates an exemplary Loop Detection Algorithm that is utilized by the State Listener according to embodiments of the invention.

FIG. 9 illustrates an exemplary state diagram of one embodiment of a State Comparison Algorithm.

FIG. 10 illustrates an exemplary block diagram of an exemplary Automated Crawler according to embodiments of the invention.

FIG. 11 illustrates an exemplary block diagram of exemplary Automated Crawler Navigation Logic according to embodiments of the invention.

FIG. 12 illustrates an exemplary apparatus employing attributes of the Recording/Control Environment according to embodiments of the invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be used and structural changes may be made without departing from the scope of the preferred embodiments of the present invention.

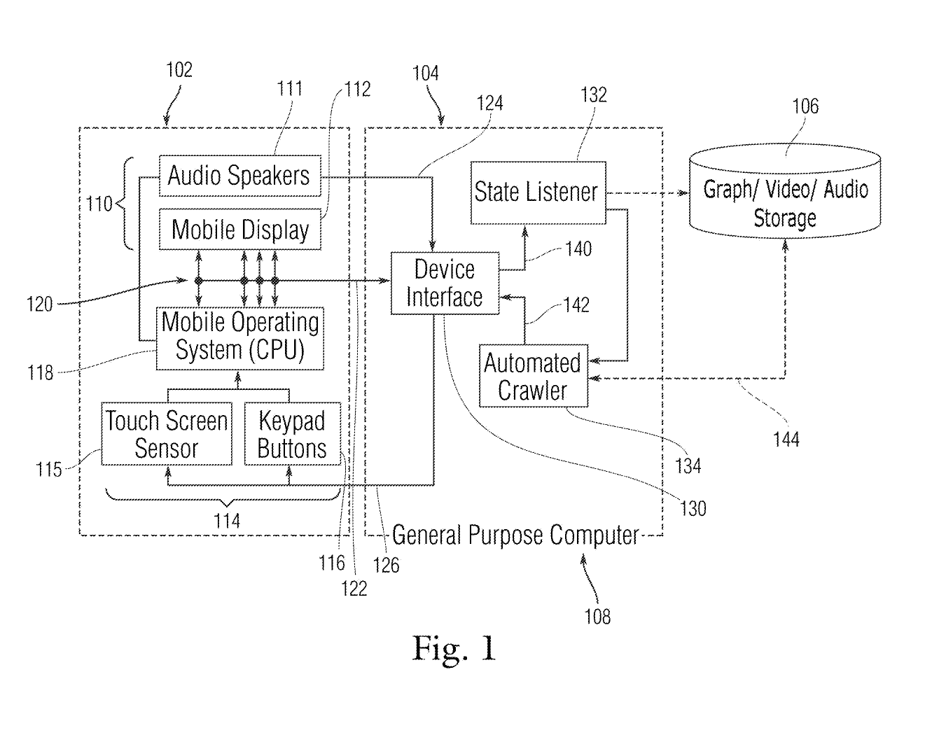

FIG. 1 illustrates a representative block diagram of one embodiment for a system to generate a map of an automated menu system. The system is used to navigate through the various options of a mobile device and record the audio and video data resulting and corresponding to various user inputs. Using this data, a Mobile Emulator is created to permit a user to externally navigate the device to experience a reliable, extensive, interactive preview of the device's options and capabilities.

The Mobile Device 102 is a portable information processing device, which may include such devices as a cell phone, PDA, GPS units, laptops, etc. The most common configuration of a Mobile Device is a small handheld device, but many other devices such as digital audio players (e.g. MP3 players) and digital cameras are within the scope of the present invention. The Mobile Device 102 is commonly used to execute or view Mobile Applications and Services. The Mobile Device 102 is integrated with the Recording/Control Environment 104. The environment has the ability to control the Mobile Device, and record the resulting display and audio data, including images or video, that is produced. The data generated is then stored in the Graph/Video/Audio Storage 106.

The Mobile Device 102 may include various user interactive features or output devices, such as speakers, or visual displays, etc. The visual display or sounds generated from the Output Devices 110 may be included in the data captured by the Recording/Control Environment 104. Audio speakers 111 may generate sound when keys are pressed, or when applications are running on the device. The Mobile Device 102 may additionally or alternatively include a Mobile Display 112. The Mobile Display 112 is used to display information about the status of the Mobile Device and to allow interaction with the Mobile Device. The Mobile Display may be a flat panel LCD display, but could also be made from any other display types such as Plasma or OLED technologies.

In addition to output devices, the Mobile Device 102 may include Input Devices 114, such as a touch screen, keypad, keyboard, or other buttons. Touch Screen Sensor 115 can be used to select menus or applications to run on the device. The Touch Screen Sensor 115 may be a touch sensitive panel that fits over the LCD display of the device or works in conjunction with the LCD display, and allows a user to use a stylus or other object to click on a region of the screen. Alternatively, or in addition to the touch screen, the mobile device may use keypad buttons 116 to navigate between menus on the device, and to enter text and numerical data on the device. A typical Mobile Device 102 has a numerical pad with numbers 0-9, #, *, and a set of navigation keys including directional arrows, select, left and right menu keys, and send and end keys. Some devices may have full keypads for entering numerical data, or may have multiple keypads that are available in different device modes.

The Mobile Device 102 may additionally include a Mobile Operating System 118. The Mobile Operating System 118 does not necessarily have to be housed within the Mobile Device 102, but may alternatively be external to the device and use a communication link to transfer the required information between the device and the operating system. This operating system 118 may be used to control the functionality of the Mobile Device 102. The operating system 118 may be comprised of a central processing unit (CPU), volatile and non-volatile computer memory, input and output signal wires, and a set of executable instructions that control the function of the system. The Mobile Operating System 118 may be an open development platform such as BREW, Symbian, Windows Mobile, Palm OS, Linux, along with various proprietary platforms developed by Mobile Device manufacturers.

In one embodiment, Communication Data and Control Signals 120 make up the information that is being transferred from the Mobile Operating System 118 to the Mobile Display 112 with the purpose of forming graphical images, or displaying other information on the Mobile Display 112. As the information passes from the Mobile Operating System to the Mobile Display, translations of the display information may occur by various intermediate hardware graphics processors. The translations may be simple, such as converting a parallel data stream (where data is transferred across many wires at once) into a serial data stream (where data is transferred on a smaller number of wires). There may alternatively be more complex translations performed by a Graphics Processing Unit (GPU) such as converting higher level drawing or modeling commands into a final bitmap visual format. Although the information may take different forms at various processing stages, the information is meant to accomplish the task of displaying graphical or other information on the Mobile Display 112.

Video Data 122 from the Communication Data and Control Signals 121 is sent to the Recording/Control Environment 104. The raw information from the Communication Data and Control Signals 120 is extracted, or intercepted and copied, and made available to the Recording/Control Environment 104. The interception may passively copy the information as it is being transferred to the Mobile Display 112, or it may use a disruptive approach to extract the information. Although a disruptive approach to extract the communication data may interfere with the operation of the Mobile Display, this may be immaterial in cases where only the Recording/Control Environment 104 is needed to interact with the Mobile Device 102.

The interception and copying may be accomplished by a hardware sensor that can detect the signal levels of the Communication Data and Control Signals 120 and make a digital copy of that information as it is being transferred to the Mobile Display 112. Generally available products such as Logic Analyzers can perform this task, as well as custom hardware designed specifically to extract this digital information from Mobile Devices. A similar software agent based approach may alternatively be used to extract the raw information that is fed into the Recording/Control Environment 104. In this instance, the software agent would be a software program running on the Mobile Operating System 118 itself and communicating with the Environment 104 through any standard communication channel found on a Mobile Device 102. This communication channel could include over-the-air communication, USB, Serial, Bluetooth, or any number of other communication protocols used for exchanging information with an application running on a Mobile Operating System.

The Audio Data 124 is all of the aural information that is available on the Mobile Device 102. This information may be extracted from the physical device by means of an analog to digital converter, to make the audio data available to the Recording/Control Environment 104. This is may be done by either connecting to the headset provided with the device, or removing the speakers from the device and connecting to the points where the audio would be generated to the speakers. This information could also be extracted from the Mobile Device 102 in native digital audio format, which would not require a conversion to digital.

The Navigation Control 126 is the system to control the Mobile Device 102 from the Recording/Control Environment 104. The most desirable integration with the device is to use a hardware based integration to electrically stimulate keypad button presses and touch screen selections. This could also be controlled using software interface with the device operating system 118. The software interface could communicate with a software agent running on the device through the device data cable, or through an over the air communication such as Bluetooth. The Navigation Control can control all of the Input Devices 114 of the Mobile Device 102 in a reliable manner.

The Graph/Video/Audio Storage 106 is a repository of information which is stored during the design-time recording of the Mobile Device 102 interactions. The storage system can be a standard relational database system, or could simply be a set of formatted files with the recording information. The recording information generally takes the format of database table elements representing a large multi-directional graph. This graph represents the map of the structure of the menus and applications on the Mobile Device 102. Additionally, the storage system contains audio, video, and/or still frame information that was recorded from the Mobile Device 102.

Graph Data 144 is constructed from the persistent information stored in the Graph/Video/Audio Storage 106 component. Keeping the Graph Data 144 in memory allows multiple sub-systems to read and write multiple changes to the storage component with atomic transactions, which avoids concurrent modification of the persisted data. This also allows those sub-systems to perform complex operations on the Graph Data 144, for example searching, without having to repeatedly access the storage component 106, which may have a slower response time due to hardware constraints or physical proximity. A proprietary framework of generated in-memory structures may be employed with XML messaging to transmit data to the storage system 106. Other possible implementations exist, including frameworks such as Java Beans, Hibernate, direct JDBC, etc.

The Recording/Control Environment 104 may be run on a General Purpose Computer 108 or some other processing unit. The General Purpose Computer 108 is any computer system that is able to run software applications or other electronic instructions. This includes generally available computer hardware and operating systems such as a Windows PC or Apple Macintosh, or server based system such as a Unix or Linux server. This could also include custom hardware designed to process instructions using either a general purpose CPU, or custom designed programmable logic processors based on CPLD, FPGA or any other similar type of programmable logic technologies.

The Recording Environment 104 identifies the unique states, or pages, of the device user interface, and establishes the navigation links between those pages. Navigation links are defined as the Input Device 114 functions that must be manipulated to navigate from one page of the Mobile Device 102 to another page. The Recording Environment 104 can be used by a person manually traversing through the menus of the Mobile Device 102, or could be used by an automated computer process that searches for unmapped navigation paths and automatically navigates them on the device.

In one embodiment, the Recording/Control Environment 104 includes a Device Interface 130. The Device Interface 130 is responsible for Navigation Control 126 of the Mobile Device 102 and processing and buffering Audio Data 124 and Video Data 122 coming back from the Mobile Device 102. A USB connection may be used to communicate with the hardware or software that interacts with the physical Mobile Device 102. This communication channel could include, however, over-the-air communication, Serial, Bluetooth, or any number of other communication protocols used for two-way data transfer. The Device Interface 130 provides the State Listener 132 with Audio/Video 140 data, which is the Audio Data 124, Video Data 122, and Navigation Control 126 events from the Mobile Device 102 in a common format. It also allows a human user or the Automated Crawler 134 to send Navigation 142 events to the Mobile Device 102 in a common format.

In one embodiment, the Recording/Control Environment 104 additionally includes a State Listener 132, which polls the Device Interface 130 for audio data, video data, and navigation events. When data is coming back from the Mobile Device 102, the State Listener 132 enters a transitional state and tracks the navigation event that led to this transition. The State Listener 132 keeps a buffer of audio and video data from the Device Interface 130 until the data either stops or loops for a configured period of time. At that point, the State Listener 132 compares the data in its buffer to existing states in the graph, and either creates a new state in the graph or updates its current state if a match is found. The State Listener 132 also creates a link from the previous state to the current state in the graph for the navigation event associated with the data buffer, if that link does not exist in the graph already. Finally, the State Listener 132 enters a stable state and waits for further output from the Device Interface 130.

In another embodiment, the Recording/Control Environment 104 includes an Automated Crawler 134. The Automated Crawler 134 is started by a human operator, and follows an iterative process to expand the Graph data 144 by finding states in the graph where all possible navigation events leading out of that state have not been explored. The Automated Crawler 134 then navigates to the screen on the Mobile Device 102 corresponding to the state, and sends a navigation event corresponding to the unmapped path. In doing so, the State Listener 132 will create a new outgoing link from that state for the navigation event, so the next time the Crawler 134 searches for an unmapped path it will find a different combination of a state and navigation event.

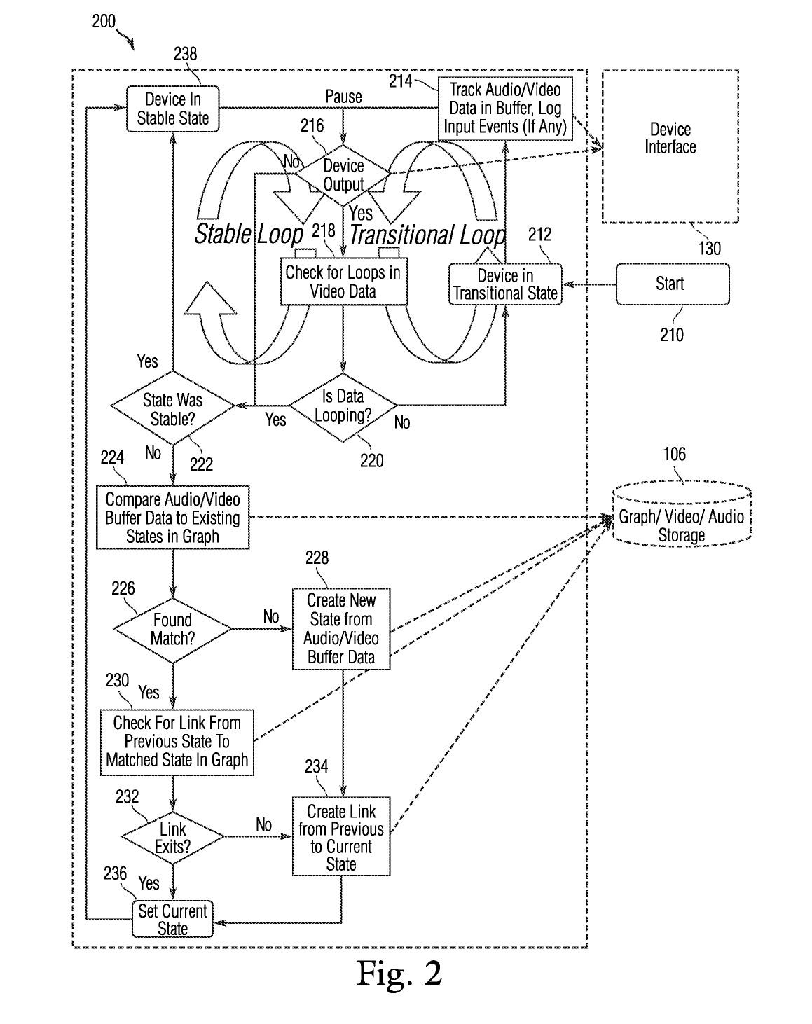

FIG. 2 illustrates a flow diagram of an exemplary state listener process 200 according to embodiments of the invention. The process 200 starts at block 210. The State Listener 132 is started by a human operator or the Automated Crawler 134. When started, it requests a full frame of video data from the Device Interface 130 and stores it in its video buffer. The State Listener 132 continues until it is manually stopped by a human user, or until the Automated Crawler 134 finishes its processing.

When there is new, non-looping data coming from the Mobile Device 102, the State Listener 132 clears its current state which indicates that the Mobile Device 102 is in a transition at block 212, Device In Transitional State. Other systems such as the Automated Crawler 134, or a human operator, may check the State Listener 132 to see if the Mobile Device 102 is in transition. If so, they should avoid sending further input to the Mobile Device 102.

Next, the State Listener 132 tracks audio data, video data, and input events 214. When the Mobile Device 102 is in a transitional state, the State Listener 132 logs recent navigation events and audio/video data from the Device Interface 130. This information is later used to populate new links and states that might be added to the graph.

The State Listener 132 waits for audio/video output from the Device Interface 130 at block 216. If none exists after a time threshold previously configured by the human operator, the State Listener 132 updates its current state, saving data in its buffer to the storage component. If new data comes from the Mobile Device 102 within this time threshold, the State Listener 132 checks the data buffer for loops and either saves the incoming data, or if the data is looping, updates its current state as if no data had arrived.

Sometimes there are states on a Mobile Device 102 that continuously generate audio or video data in a deterministic cycle and never stop. Therefore, when audio/video data comes from the Mobile Device 102 via the Device Interface 130, the State Listener 132 checks to see if it is part of an infinite loop 218. First, the State Listener 132 looks for previous instances of the current data in the data buffer. Then, the State Listener 132 looks backwards from the current data to see how many iterations of a current sequence existed previously in the buffer in the same order. If the data exists in a number of iterations greater than a threshold value previously configured by the human operator, the State Listener 132 decides that the Mobile Device 102 is in an infinitely looping state. After that, any data coming from the Mobile Device 102 that continues the current pattern in the same order is ignored. If the data is not infinitely looping, the State Listener 132 clears its current state and adds the data to the buffer.

Once the State Listener 132 has determined that new, non-looping data is no longer coming from the Mobile Device 102 at block 222, it begins the process of updating its current state. First 224, the State Listener 132 searches for states in the saved graph structure that contain audio and video data that exists in the data buffer, in the same order. For portions of the data buffer that contain loops, the matching algorithm attempts to shift the loop forward and backward to see if it aligns with looping data in the target state in the graph. If any matching target state exists in the graph 226, the State Listener 132 assumes that is the current state of the physical Mobile Device 102. If not, it begins the process of creating a new state in the graph.

If no match was found for the data in the data buffer 226, the State Listener 132 creates a new state in the graph 228. The data in the data buffer is then transformed and associated with that state 106. The data buffer is cleared. If a match was found for the data in the data buffer 226, the State Listener 132 first removes all data from the data buffer that exists on the target state. It then checks 230 to see if the target state in the graph has an incoming link from the State Listener's previous state for the navigation event that occurred on the Mobile Device 102. If such a link exists 232, no new link is created. If no such link exists 232, the State Listener 132 creates 234 a new link in the graph 106. The State Listener 132 creates 234 a new link from its previous state to the current state, for the navigation event that exists in the buffer. The State Listener 132 also associates any remaining audio/video data left in the data buffer with that link.

Once the State Listener 132 has created any new entities in the stored graph structure, it sets 236 its current state to be either the matched state in the graph (if one existed) or the new state that was just created. This indicates that the Mobile Device 102 is no longer in a transitional state 238. Other systems such as the Automated Crawler 134, or a human operator, take this information to mean that another navigation event can be sent to the Mobile Device 102.

After settling on the state in the graph that matches the contents of the data buffer coming from the Mobile Device 102, either by matching an existing state or creating a new one, the State Listener 132 considers the Mobile Device 102 to be in a stable state 238. This continues to be true until the State Listener 132 detects a transitional state, specifically when non-looping audio/video data comes from the Mobile Device 102. Other systems such as the Automated Crawler 134, or a human operator, may check the State Listener 132 to see if the Mobile Device 102 is in a stable state. If so, they know that it is safe to send navigation events to the Mobile Device 102, which may trigger a state transition.

There are several technical challenges that the State Listener 132 may have to overcome when processing audio and video data from the Mobile Device 102 and comparing new states on the Mobile Device 102 with existing nodes in the saved graph structure 106. First, there should be a reliable means of representing video data in the buffer that allows fast update and comparison of images. Second, there may be content in the video feed from the Device Interface 130 that changes irrespective of user navigation (“Dynamic Content”). If not detected, this data could result in two states that a human considers logically identical appearing as distinct to the State Listener 132. Third, there may be states on the Mobile Device 102 which have infinitely looping animations (“Loops”) and never stop. These must be detected, otherwise the State Listener 132 may never identify that the Mobile Device 102 is actually in a stable but repeating state. Fourth, the State Listener 132 may require a method of down-sampling and compressing audio and video data coming from the Device Interface 130. Otherwise, the volume of data could become intractable when saving, retrieving, or comparing nodes in the graph. Finally, if video data is down-sampled, there should be a way to reliably compare states on the Mobile Device 102 with those transformed and stored as nodes in the graph 106. This method should be tolerant of data that is lost during the transformation process.

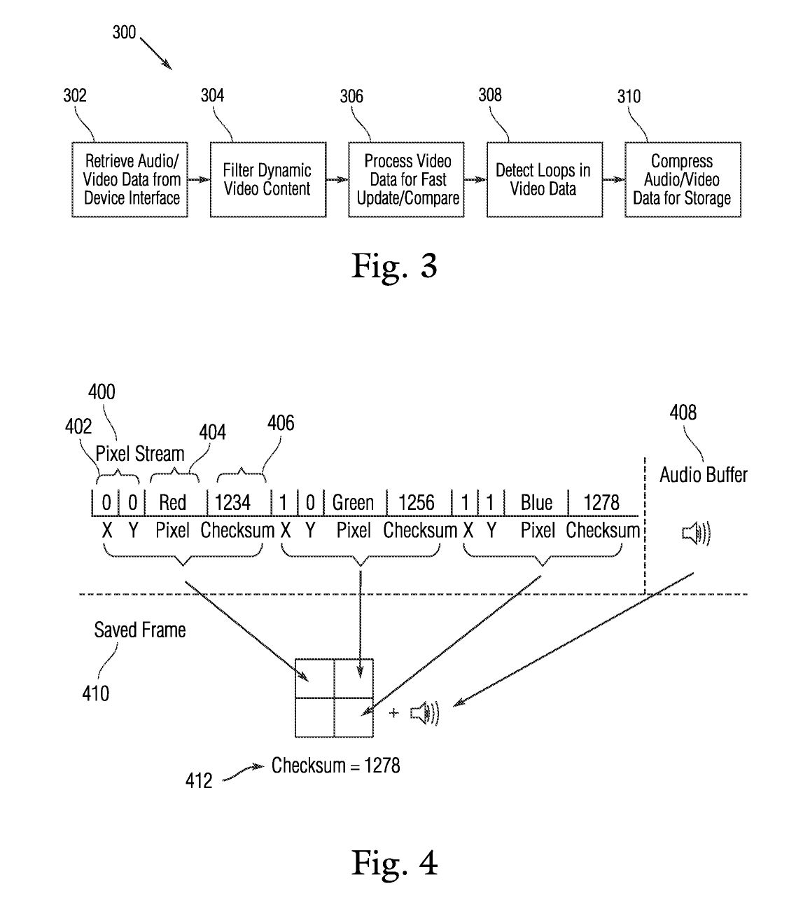

FIG. 3 is a block diagram of exemplary audio/video processing steps within the State Listener 132 according to embodiments of the invention. First 302, the State Listener 132 retrieves Audio/Video 140 data from the Device Interface 130. Second 304, the Dynamic Content is filtered. Next 306, the State Listener processes video data for fast updating and comparison. Then 308, the State Listener detects loops in the video data. Finally 308, the resulting audio and video data is compressed for data storage. It is contemplated by this invention that the process of the State Listener 132 may be performed in varying order, or that a block may be completely removed from the process. For example, if the resulting data for storage is not very large, the data may not need to be compressed for storage as in the last block 310. Each block is described further below according to some embodiments of the invention.

The first block 302 of the State Listener 132 process 300 is to retrieve the Audio/Video Data from the Device Interface 130. Audio/Video 140 data streams from the Device Interface 130 in real time. The State Listener 132 breaks the data into atomic units that represent discrete changes on the Mobile Device 102. For audio data, the audio samples may be a fixed length stored at discrete intervals or appended to a single audio stream. A preferred embodiment of the present invention stores the audio buffer as a sequence of fixed-length samples, but any approach that saves audio data and correlates it to video frames would work. For video data, there are several possible ways of representing the data, including as a sequence of images taken at discrete intervals, as a stream of individual pixel updates, or with a hybrid approach. The preferred embodiment of the present invention employs a hybrid approach of storing the video buffer as a pixel stream with some pre-processing, followed by a post-processing loop that collapses these pixel updates to a single image at fixed intervals. However, any method of storing video data in a manner that allows comparison with previously saved video is within the scope of the invention. FIG. 4, described further below, illustrates one embodiment of an audio/video buffer format.

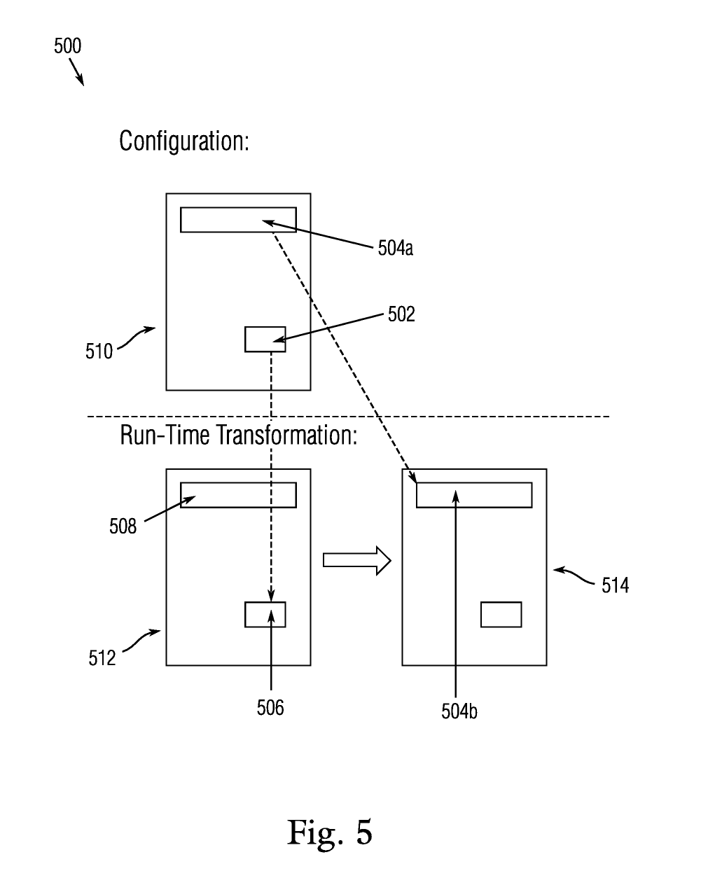

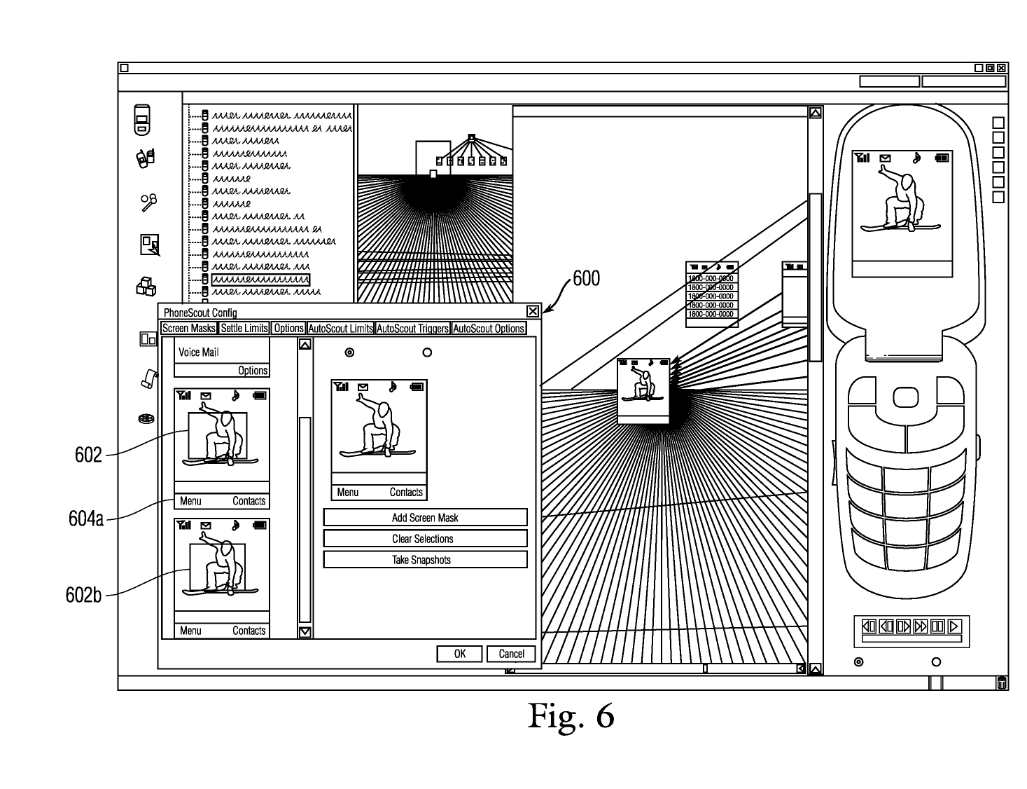

The second block 304 is for the State Listener 132 to filter Dynamic Content. Sometimes pixels on the video display of a Mobile Device 102 change irrespective of any navigation event. Examples include clock displays, battery indicators, signal strength indicators, calendars, etc. This Dynamic Content can change the image on the display, causing the State Listener to interpret a state change on the Mobile Device 102, when in fact a human user would logically interpret the Mobile Device 102 to be in the same state. There are several possible ways of handling this Dynamic Content, including using heuristic image matching algorithms that ignore such content when comparing images, using text extraction to identify the content and replace it in the image buffer, or using image comparison on other regions of the display to identify when Dynamic Content should be masked, and masking the content with that of a previously saved image. A preferred embodiment of the present invention uses the latter approach, though any solution that filters or handles the Dynamic Content is within the scope of the present invention. Exemplary embodiments for Dynamic Content masking logic is further disclosed below, with regard to FIGS. 5 and 6.

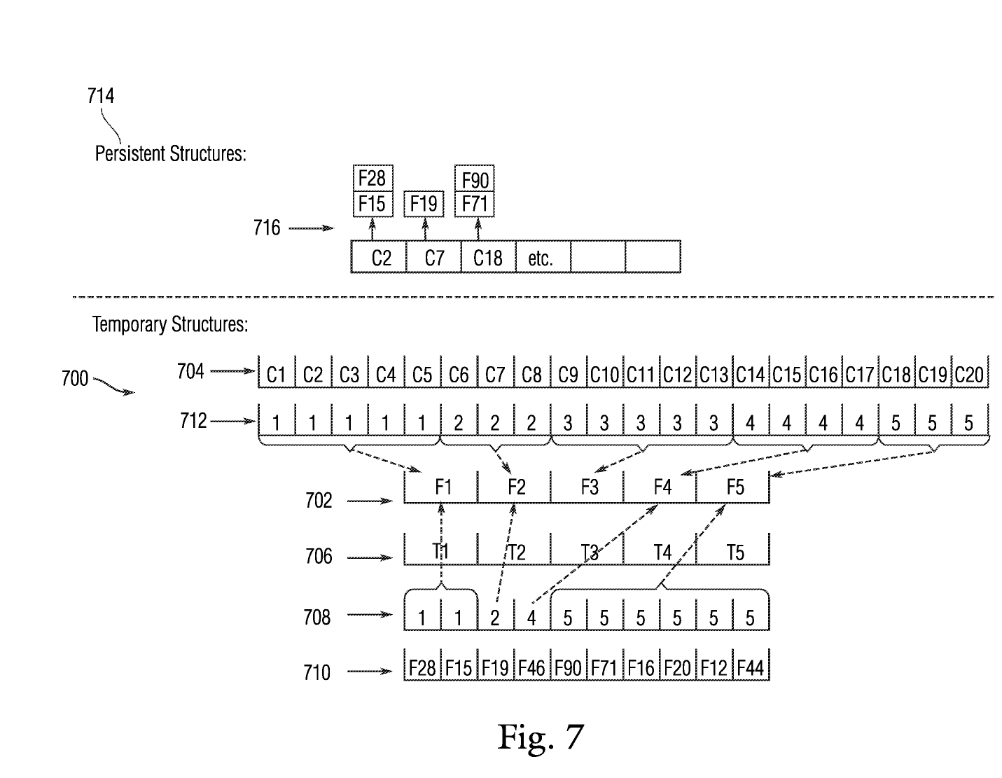

Next 306, the State Listener 132, processes video data for fast updating and comparison. Because of the volume of data coming from the Mobile Device 102, it is impractical to save every unit of data to the Graph Storage 106 component. It is also impractical to compare every element of the data buffer with every element of all saved states during state comparison. Therefore, it may be necessary to use certain data structures to represent the video data to optimize memory usage and minimize computation. For some implementations, it may be enough to down-sample the video buffer by collapsing all pixel updates to a single image at certain intervals, then compressing the image and audio sample (if any). However, for implementations where video loop detection is required, or where it is desirable to match multi-frame animations rather than single static images, data structures representing the video buffer and algorithms used for comparison should be tolerant of data loss during the transformation and compression process. In a general sense, this means the video buffer must not only transform easily into a compressed version for storage, but it should also contain enough information to identify all possible compressions that could have resulted from the same buffer, regardless of any shifts in timing or sample rate that may have occurred. Any system of data structures and algorithms that meets these criteria would work, including linear traversal of a single pixel/checksum buffer during each comparison. FIG. 7, described below, illustrates audio and video processing data structures according to one embodiment of the present invention that accomplishes the same task with much less processing by using a system of hashing and lookups.

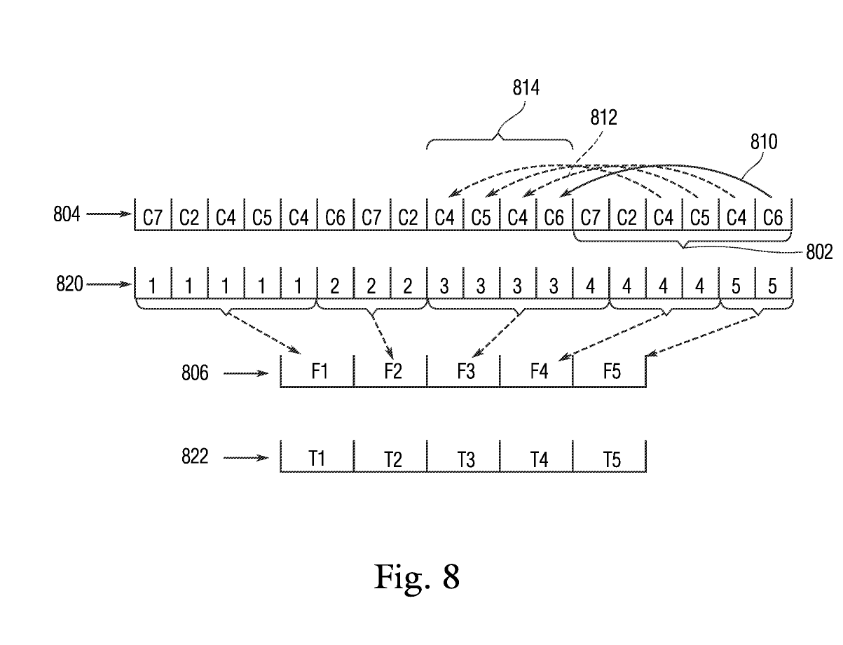

Then 308, the State Listener 132 detects loops in the video data. For Mobile Device states that consist of an infinitely looping stream of video data, there may be a way to look back in the State Listener's video buffer to find repeating sections and, for as long as they continue, ignore any further iterations. Otherwise, the video buffer could get arbitrarily long, the State Listener 132 would never detect a stable state on the Mobile Device 102, and dependent systems (such as the Automated Crawler 134) could become blocked while waiting for the Mobile Device state to stabilize. If the video buffer is resolved to image frames at discrete intervals, it may not be possible to detect loops based on the frames alone, as the frame capture interval may never synchronize with the interval of the loop on the Mobile Device 102, resulting in a sequence of non-repeating images. If a checksum hit buffer is being used, it would be possible to detect loops by searching for repeating instances of frames in the current frame buffer that also appear in the checksum hit buffer. However, this approach can result in a proliferation of entries in the checksum hit buffer. Another approach is to simply look for loops in the checksum buffer, as any looping state on the Mobile Device 102 will cause the exact same pixel updates over and over. FIG. 8, described below, illustrates an exemplary loop detection algorithm.

Finally 310, the State Listener 312 compresses the audio/video data for storage. When it has been determined that a state represented by the audio/video buffer needs to be saved in the graph, the data may be post-processed to further compress it for storage. There are many ways to compress audio and video data. Specifically, both JPEG and GIF image compression are supported, and audio samples can be compressed by converting the audio sample rate and saving as a WAV file. However, other methods of compression such as MPEG, PNG, etc. are within the scope of the invention. The compression method should be capable of comparing compressed data with the contents of the State Listener's audio/video buffer. The preferred embodiment of the present invention simply saves the checksum calculated from the source (uncompressed) data with the compressed result, and uses checksums for comparison.

FIG. 4 illustrates an exemplary audio/video buffer format as used in the first block 302, Retrieve Audio/Video Data from Device Interface, of FIG. 3. In one embodiment, video data coming from the Device Interface 130 is stored as a stream of pixel updates 400, each with an XY coordinate 402, a pixel value 404, and an image checksum 406 that is calculated during pre-processing of each pixel. The checksum is a cumulative hash of every pixel in the image that can be updated quickly for any single-pixel change, simply by subtracting the hash value of the old pixel and adding the hash value of the new pixel. Any pixel updates that don't change the calculated checksum are omitted from the buffer to save memory and processing. The Device Interface 130 calculates the checksum from the full image when the State Listener 132 starts, and updates the running checksum of the image incrementally for every pixel change after that.

Every iteration of the State Listener's polling loop takes each pixel update in the stream, applies them to the current image, saves the image, associates the image with the last checksum value, and associates a sample of audio data 408 (if any). This saved structure of an image, checksum value, and audio sample is called a “Frame” 410. Although data may stream from the Mobile Device 102 at a very high rate, frames 410 are only saved at the rate of one per polling loop. Frames can be compared to each other by comparing checksum values and, if they are equal, optionally by comparing audio samples. Frames are indexed 412 by checksum in a data structure for fast lookup. Collapsing pixel updates to a single image at discrete intervals effectively down-samples video coming from the Mobile Device 102, resulting in less consumption of storage space when the state is saved to the graph.

FIG. 5 illustrates a functional block diagram of dynamic content masking logic as used in the second process block 304 of the State Listener 132 from FIG. 3. The presence of Dynamic Content on the Mobile Display 112 is identified by comparing a region of the screen with the same region of an image that was selected by a human user as part of the State Listener configuration (“Mask Configuration”) 500. During configuration, the user selects a region of the screen that identifies it as a screen that contains Dynamic Content (“Condition Region”) 502. The user also selects a different region of the screen that represents the location of the Dynamic Content (“Mask Region”) 504a. This image is stored for comparison purposes. Then, when the Condition Region 506 of the Mobile Device Display 112 matches the contents of the stored image in the configuration 502, the contents of the Mask Region 504a of the stored image are inserted into the video buffer 504b, overwriting any Dynamic Content 508 in that region of the screen that may have been inserted into the buffer earlier. Any further pixel updates coming from the Dynamic Content 508 region on the Mobile Device 102 are omitted from the video buffer until the contents of the Condition Region 506 no longer match that of the stored image 502.

FIG. 6 is an illustration of an exemplary Mask Configuration Tool as described in FIG. 5. In the above example, a Mask Configuration 600 is shown for the mobile display showing the home page with a clock and calendar display. The Condition Region 602 selected is part of the static image on the home page, and the Mask Region 604a contains the entire clock and calendar display area. Therefore, when the screen identified by the static image in the Condition Region 602 is identified, the contents of the saved Mask Region 604b sub-region will be populated in the video buffer, and no pixel updates from the changing clock and calendar display will be inserted on the buffer. As soon as the Mobile Device 102 no longer displays the static background image 602b, the State Listener 132 will start receiving pixel updates from the region that was previously being masked.

Any comparison algorithm can be used to identify that a Condition Region 604b matches a Mask Configuration 600, including a linear search of all pixels or a regional checksum comparison. In a preferred embodiment, a regional checksum is used, where one running checksum is kept for each Mask Configuration 600 and updated any time a pixel in the Condition Region 604b changes. When the checksum for a Mask Configuration 600 matches the checksum of the Mask Region 604a in the stored image, the Mask Region 604a is updated in the video buffer as described above. This method allows for fast comparison of image regions, however any other method of performing this comparison is within the scope of the invention.

FIG. 7 illustrates exemplary Audio/Video Processing Data Structures 700 as used in the third block 306 of FIG. 3 for the Audio/Video processing of the State Listener 132. The State Listener 132 keeps a buffer of frames 702, but for loop detection purposes it may also keep a buffer of all checksums 704 seen in the current state, even though these are not persisted in the Graph Storage component 106 once the state stabilizes. There may also be a checksum to frame index lookup 712. Additionally, the State Listener 132 keeps timing information 706 for all frames, as well as a data structure for lookup of persisted frames by checksum 708. When a checksum in the checksum buffer matches one or more persisted frames, it is tracked in a checksum hit buffer 710. For persistent structures 714, the State Listener 132 uses a frame lookup hashed by checksum 716. The data structures may be temporary structures that are cleared after every state change of the Mobile Device.

The checksum hit buffer 710 tracks all frames that were matched during any individual pixel update, rather than just those frames that match frames in the current frame buffer. For Mobile Device states that consist of a single image, this is not important, as each state would only result in one frame in the buffer. For Mobile Device states that consist of an animation before settling into a static image, however, the timing of frames saved to the frame buffer could shift slightly, resulting in a single state that could be represented by entirely different frames in the frame buffer, except for the last frame. Furthermore, if the animation loops indefinitely, a shift in the frame buffer could mean that the same state can be represented in the frame buffer with two or more completely distinct sets of frames. Keeping a buffer of all checksum hits ensures that this will not happen.

FIG. 8 illustrates an exemplary Loop Detection Algorithm that may be utilized in the fourth block 308 of the Audio/Video processing performed by the State Listener 132. For an example, represented by FIG. 8, the loop 802 C7-C2-C4-C5-C4-C6 in the checksum buffer 804 repeats 3 times, with the first loop showing up in frames F1 and F2, the second loop in frames F2 and F3, and the third loop in frames F4 and F5 in the frame buffer 806. This results in frame F1 having checksum C4, F2 has checksum C2, F3 has C6, F4 has C5, and F5 has C6. By looking at frames F1 through F5, it is not possible to tell that the Mobile Device state is looping. But by looking at the checksum buffer from the pixel update stream, it is possible.

By starting from the last checksum and working backwards, loops in the checksum buffer can be detected. The loop detection algorithm simply looks for prior instances of the last checksum 810, and any time it finds one, continues backwards from the match to see if prior checksums match checksums before the current one 812, in order. If the string of matches 814 ends before the entire space between the two initial matches has been traversed, there was no loop. If the space between the two initial matches is replicated entirely, a potential loop has been found.

The loop detection algorithm continues to look backwards to see how many iterations of the potential loop exist. If the number of iterations of the potential loop is greater than a previously configured threshold value, the animation is considered to be a loop. All subsequent checksums coming from the Device Interface 130 that match the same pattern will be ignored, which also means no more frames will be added to the frame buffer. If a checksum is received that does not match the expected pattern, the loop has ended and checksums and frames are appended to the buffers once again.

Loop detection is a computationally-intensive operation, so it is helpful to restrict the algorithm to only search for loops of a specified duration. By using the checksum to frame index lookup 820 and checking the time of previous frames 822, the loop detection algorithm can avoid searching for loops that are arbitrarily short, or searching for loops in extremely long animations. The minimum and maximum duration thresholds for loop detection can be configured by a human operator.

Once the State Listener 132 has determined that the Mobile Device state has stabilized, it may compare the contents of the data buffer with existing nodes in the saved graph to see if a match exists (block 224 from FIG. 2). Generally, there are 2 cases to consider; either the video buffer ended in a single static image, or it ended with an infinitely looping animation.

In the case of a static image, any matching node in the graph must end in an image that matches the last one in the buffer. For states in which a transitional animation preceded the static image, there are several possible approaches. In the simplest solution, the State Listener 132 can drop all transitional animations and only store a single-frame image per node. An improvement on this approach is to associate any transitional images with the link between two nodes in the graph. This could result in duplication of data, however, as many paths to the same state could share some or all of the same transitional images. A preferred approach is to initially save all transitional images as part of the destination node, and each time that node is matched by a state on the Mobile Device, to keep the intersection of all checksum hits on the data buffer with the frames on the saved node. Frames in the State Listener's data buffer not in this intersection are associated with the incoming link associated with the current Navigation Event, while frames on the saved node not in the intersection are moved to the end of each animation for all other incoming links. This approach ensures that the saved node in the graph will contain the largest set of transitional frames common to all possible incoming paths, while accurately representing all other transitional animations as specific to the incoming links to which they are associated.

In the case where the data buffer ends in a loop, the same concepts apply as if it ended in a static image, except the loop must be treated as an atomic entity. In other words, any node in the graph should also end in a matching loop. Prior to the loop, the State Listener 132 can take any of the above approaches to associating transitional animations. In a preferred embodiment, the same approach of finding the intersection of all transitional animations and distributing other frames among incoming links is taken. Matching infinitely looping animations is more complex than matching static frames. The same problems exist as when comparing single animations, except the Mobile Device may not always begin displaying the animation at the same point. Therefore, any method of comparing looping animations should employ some method of shifting the looping portion in a circular data structure during comparison to handle this case. In a preferred embodiment, the contents of the checksum hit buffer corresponding to checksums that are part of the loop are shifted when checking for a match to any existing looping animations, but other methods, including shifting the looping portion of the pixel stream, are within the scope of the invention.

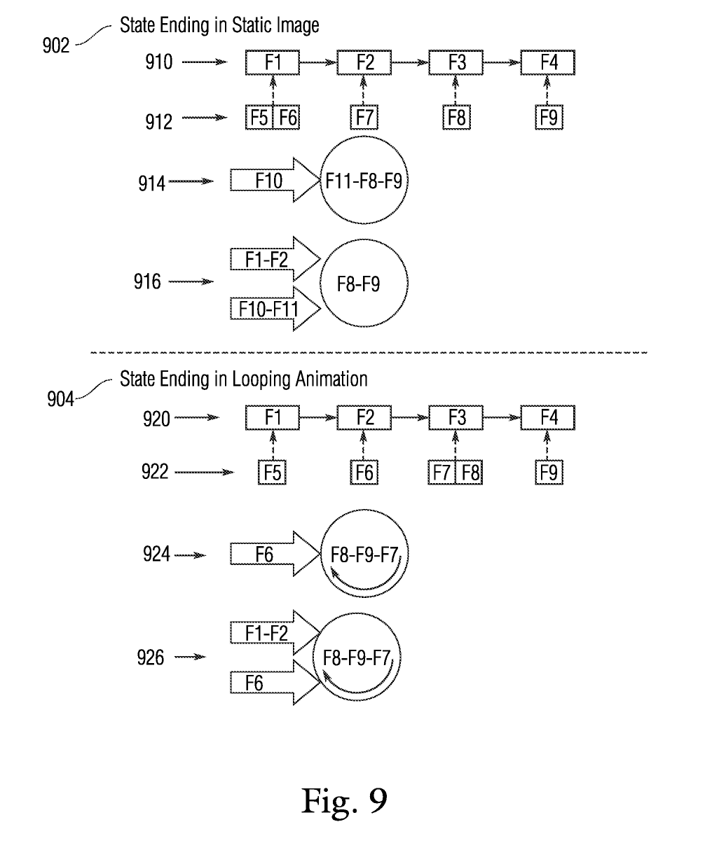

FIG. 9 represents a state diagram of one embodiment of a State Comparison Algorithm. The two cases to consider—either the video buffer ended in a single static image 902, or it ended with an infinitely looping animation 904—are described.

If the frame buffer ends in a static image 902, any node which ends in the same static image is considered a potential match. In the example in FIG. 9, the State Listener 132 would search the Frame buffer 910 for all frames which have the same checksum as frame F4, get the nodes to which they belong, and keep only those which end in the matching frame. If more than one such node exists, the State Listener 132 looks backwards in the checksum hit buffer 912 to find the one that matches the most consecutive frames in order. In the example, the matching node ended in frames F9 and F8, which matched the final frame F4 and a checksum seen during the processing loop that resulted in frame F3, respectively. If an incoming link already exists for the current navigation event, a matched state exists, 914, the current state is updated 916 and no new link is created. Otherwise, any prior non-matching frames on the frame buffer are considered pre-ambles to the matching portion and are associated with the new incoming link created for the current navigation event; in this case, frames F2 and F3 were associated with the new incoming link. Likewise, any prior non-matching frames on the saved node are considered pre-ambles to the matching portion and are moved to the end of animations associated with any existing incoming links; in this case, frame F11 was moved to the end of existing incoming links.

If the frame buffer 920 ends in a looping animation 904, the State Listener 132 searches for frames in the checksum hit buffer 922 that are part of a looping animation at the end of an existing node. In the example, the State Listener 132 would consider frames F6, F7, F8, and F9, and find any nodes ending with a looping animation that contains one or more of these frames. Then, the State Listener 132 attempts to shift the looping portion of the checksum hit buffer one at a time to see if all frames in any existing looping animation were matched in order. In the example 904, the State Listener 132 would consider the checksum hit buffer sequence F6-F7-F8-F9, then F9-F6-F7-F8, then F8-F9-F6-F7, then F7-F8-F9-F6. On the third iteration, the looping animation F8-F9-F7 that ends an existing node would match 924. If an incoming link already exists for the current navigation event, the current state is updated 926 and no new link is created. Otherwise, any prior non-matching frames on the frame buffer are considered pre-ambles to the matching portion and are associated with the new incoming link created for the current navigation event; in this case, frames F1 and F2 were associated with the new incoming link. Likewise, any prior non-matching frames on the saved node are considered pre-ambles to the matching portion and are moved to the end of animations associated with any existing incoming links; in this case, no such frames existed so incoming links were left unchanged.

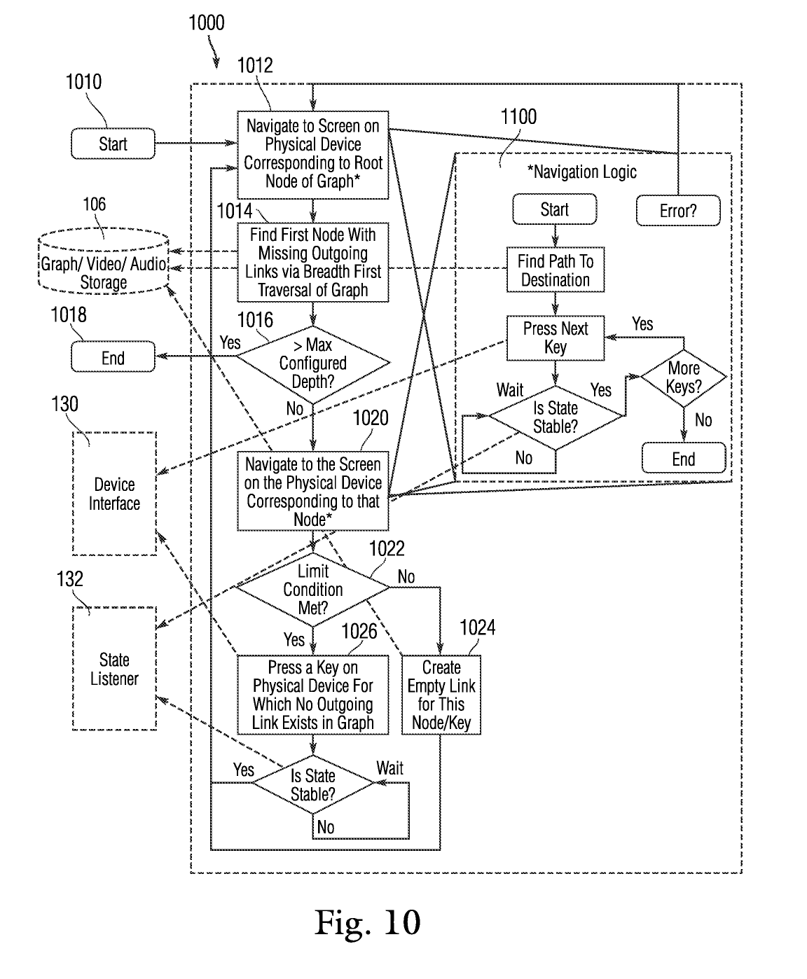

FIG. 10 is a block diagram of an exemplary Automated Crawler 134 logic 1000 according to embodiments of the invention. First, the Automated Crawler 134 is started 1010 by a human operator. If the State Listener 132 has not been started already, the Automated Crawler 134 starts the State Listener 132 and waits for it to indicate that the Mobile Device 102 is in a stable state before continuing. The Automated Crawler 134 also checks to make sure the Root node of the graph has been defined, and that the path of navigation controls leading to the Root node has been configured.

The Automated Crawler 134 retrieves the path of navigation events leading to the Root node, which are saved in the graph by a human operator as a configuration setting. The Automated Crawler 134 then sends these navigation events to the Mobile Device 102 to get it in a known state 1012.

In one embodiment, the Automated Crawler 134 performs a breadth-first traversal of every node in the graph until it finds one which does not have an outgoing link defined for every possible navigation event 1014. The Automated Crawler 134 finds which navigation events are supported by the Mobile Device 104 by querying the Device Interface 130. By filtering this list by the list of navigation events for outgoing links, the Automated Crawler 134 finds those navigation events that have not yet been attempted for that state on the Mobile Device 102.

The Automated Crawler 134 can be configured to only navigate to states on the Mobile Device 102 that are less than a certain number of navigation events away from the Root state. If the nearest node not fully mapped is further away than this number of navigation events, the Automated Crawler 134 has no more work to do and stops. If the Automated Crawler 134 has such a limiting feature, then it checks to ensure it is still within the maximum configured depth 1016. If the maximum depth is exceeded, then the Automated Crawler 134 ends 1018.

If the maximum depth has not been exceeded, and once a node that is not fully mapped has been found, the Automated Crawler 132 navigates to that state on the Mobile Device 1020. Once the Automated Crawler arrives at its target node, it checks to see if there are any Limit Conditions configured for that state 1022. In certain cases, navigation events may be enabled or disabled based on the audio or video data present on the Mobile Device, in order to restrict the Automated Crawler 134 from continuing down undesired paths.

For any navigation events disabled by a Limit Condition, the Automated Crawler 134 creates an empty outgoing link for that node and navigation event 1024. This indicates to the graph traversal algorithm that the path has been considered, even though it was not followed, and the node will appear as fully mapped to the algorithm when all allowed navigation events have been taken.

For any allowed navigation events that do not have outgoing links from the current node 1026, the Automated Crawler 134 selects one of these and sends it to the Mobile Device 102 via the Device Interface 130. It then waits for the State Listener to indicate that the Mobile Device is in a stable state before starting the next iteration of the process.

There are certain times when, given a destination node in the saved graph structure that represents a virtualization of a Mobile Device, it is necessary to navigate to the state corresponding to that node on the physical Mobile Device 102. Two such scenarios occur during the Automated Crawler's processing loop, but other scenarios may exist as well, including when a human user wants to expand the graph structure from a given node by manually navigating the physical Mobile Device 102. In all of these cases, there must be a means of finding the node in the graph corresponding to the current state of the physical Mobile Device 102, finding the shortest path in the graph between the current node and the destination, and then sending the navigation events corresponding to that path to the Mobile Device 102. This process is described in greater detail below.

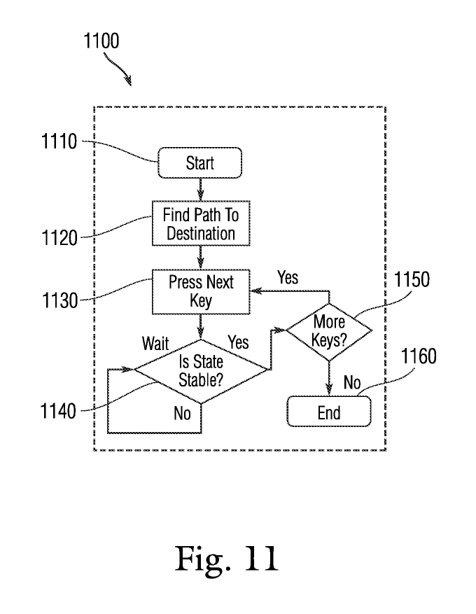

FIG. 11 is a block diagram 1100, from FIG. 10, of exemplary Automated Crawler Navigation Logic according to embodiments of the invention. The Navigation Logic 1100 is started 1110 when the Automated Crawler 134 needs to put the Mobile Device 102 in a state corresponding with a destination node in the graph. The Navigation Logic 1100 needs to know the node representing the current state of the Mobile Device 102 and the destination node in the graph.

The Navigation Logic 1100 then finds the path to the destination state 1120. If the destination is the Root node, the Navigation Logic uses the path previously configured. If the destination was found by traversal of the graph when searching for an unmapped node, the traversal algorithm found a path from the Root node to the destination that, by definition, is the shortest existing path. For any other cases, the A* algorithm for a single-pair shortest path is used, where the cost of the path is initially estimated to be no more than the length of the configured path to the Root node plus the depth of the destination node from the Root node in the graph.

The Navigation Logic 1100 then presses the next appropriate key 1130. The Navigation Logic removes the next navigation event from the path and sends it to the Device Interface to perform the navigation on the Mobile Device. The Navigation Logic 1100 polls the State Listener 132 until it indicates that the Mobile Device 102 is in a stable state 1140. The Navigation Logic also checks with the State Listener 132 to verify that, once stable, the Mobile Device 102 is in the state that was expected after the navigation event. If not, or if the state is not stable after a maximum threshold of time, the Navigation Logic 1100 determines that an error has occurred.

If more navigation events exist in the path 1150, the Navigation Logic 1100 sends the next one to the Mobile Device 102. If not, the Mobile Device 102 has either reached the destination state or caused an error. In either case, the Navigation Logic 1100 is finished with its processing 1160. If the Navigation Logic 1100 encounters an error during navigation, it returns the Automated Crawler 134 to its initial state of navigating to the Root state on the Mobile Device.

There may be screens on the Mobile Device that would interest a user of the Virtual Device that was created by the Automated Crawler, but which the Crawler does not find due to a Limit Condition or because a random sequence of navigation events is unlikely to reach the screen. Examples may include dialing a phone number, entering and sending an SMS message, or taking live photos and video with the Mobile Device. For such screens, a human operator can manually navigate the path while the State Listener is running. This captures and saves the path in the graph as during automated navigation, only with the contextual guidance of a human user.

The sequence of states captured during manual navigation can be displayed to the end user of the Virtual Device interactively, or as a non-interactive video. In the latter case, these states are collectively defined as an Endpoint Video. The human operator creating the graph representation of the Virtual Device groups the screens into a single entity and associates that entity with a node in the graph representing the entry point to the screens. When a user is navigating the Virtual Device and reaches the specified node, they are given the option of viewing the sequence of screens demonstrating specific functionality in the Endpoint Video.

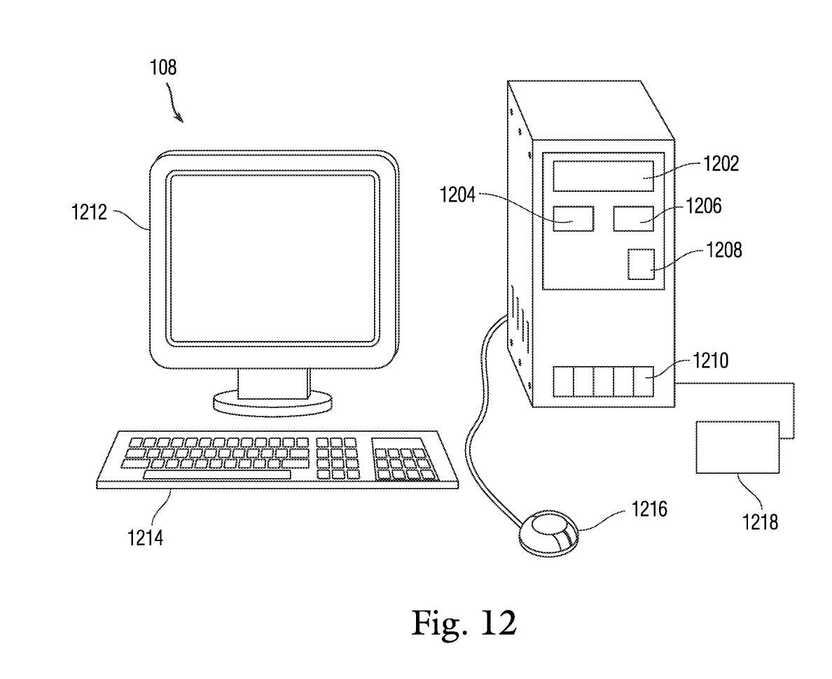

FIG. 12 illustrates an exemplary apparatus employing attributes of the Recording/Control Environment according to embodiments of the invention. The Recording/Control Environment 104 may be run on a General Purpose Computer 108 or some other processing unit. The General Purpose Computer 108 is any computer system that is able to run software applications or other electronic instructions. This includes generally available computer hardware and operating systems such as a Windows PC or Apple Macintosh, or server based system such as a Unix or Linux server. This could also include custom hardware designed to process instructions using either a general purpose CPU, or custom designed programmable logic processors based on CPLD, FPGA or any other similar type of programmable logic technologies.

In FIG. 12, the general purpose computer 108 is shown with processor 1202, flash 1204, memory 1206, and switch complex 1208. The general purpose computer 108 may also include a plurality of ports 1210, for input and output devices. A screen 1212 may be attached to view the Recording/Control Environment 104 interface. The input devices may include a keyboard 1214 or a mouse 1216 to permit a user to navigate through the Recording/Control Environment 104. Firmware residing in memory 1206 or flash 1204, which are forms of computer-readable media, can be executed by processor 1204 to perform the operations described above with regard to the Recording/Control Environment 104. Furthermore, memory 1206 or flash 1204 can store the graph node state, preamble, and transitional sequence between node information as described above. The general purpose computer may be connected to a server 1218 to access a computer network or the internet.

Note that this firmware can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples of the computer-readable medium include, but are not limited to, an electrical connection (electronic) having one or more wires, a portable computer diskette (magnetic), a random access memory (RAM) (magnetic), a read-only memory (ROM) (magnetic), an erasable programmable read-only memory (EPROM) (magnetic), an optical fiber (optical), portable optical disc such a CD, CD-R, CD-RW, DVD, DVD-R, or DVD-RW, or flash memory such as compact flash cards, secured digital cards, USB memory devices, a memory stick, and the like. Note that the computer-readable medium could even be paper or another suitable medium upon which the program is printed, as the program text can be electronically captured via optical scanning of the paper or other medium, then compiled, interpreted or otherwise processed in a suitable manner if necessary, and then stored in a computer memory.

The term “computer” or “general purpose computer” as recited in the claims shall be inclusive of at least a desktop computer, a laptop computer, or any mobile computing device such as a mobile communication device (e.g., a cellular or Wi-Fi/Skype phone, e-mail communication devices, personal digital assistant devices), and multimedia reproduction devices (e.g., iPod, MP3 players, or any digital graphics/photo reproducing devices). The general purpose computer may alternatively be a specific apparatus designed to support only the recording or playback functions of embodiments of the present invention. For example, the general purpose computer may be a device that integrates or connects with a Mobile Device, and is programmed solely to interact with the device and record the audio and visual data responses.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Many alterations and modifications can be made by those having ordinary skill in the art without departing from the spirit and scope of this invention. Therefore, it must be understood that the illustrated embodiments have been set forth only for the purposes of example and that they should not be taken as limiting this invention as defined by the following claims. For instance, although many of the embodiments of the invention describe logic processes for specific results in a particular order, it should be understood that the invention is not limited to the stated order. Two or more steps may be combined into a single step or the processes may be performed out of the stated order. For example, when the application is retrieving or storing information, the described embodiment discusses the recording or playing audio and visual data as separate steps occurring in a specific order. The present invention should be understood to include combining these steps into a single step to play or record the video and audio data simultaneously or to reverse the order so the video is retrieve before the audio, or vise versa.

The words used in this specification to describe this invention and its various embodiments are to be understood not only in the sense of their commonly defined meanings or their defined meaning by those skilled in the art, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements can be made for any one of the elements in the claims below or that a single element may be substituted for two or more elements in a claim.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined claim elements.

What is claimed is:

1. A method for identifying a current state of a mobile device for recording interactions with the mobile device, comprising:
receiving a current state from the mobile device;
separating a transitional sequence between states and a stable state from the current state; and
masking dynamic content from the stable state to identify the canonical samples that represent the stable state.

2. The method of claim 1, further comprising detecting a stable loop within the stable state.

3. The method of claim 1, further comprising comparing the stable state with previously identified states.

4. The method of claim 3, further comprising recording the stable state if a match is not found with the previously identified states.

5. The method of claim 1, further comprising creating a link from a previous state to the current state.

6. The method of claim 1, further comprising navigating to a previously unrecorded state.

7. A method for identifying a current state of a mobile device for navigating through mobile device options, comprising:
retrieving audio and video data from the mobile device;
filtering dynamic content;
processing the video data for fast comparison; and
detecting loops in the video data.

8. The method of claim 7, further comprising storing the video data as a stream of pixel updates.

9. The method of claim 7, further comprising storing the pixel updates as an XY coordinate and an image checksum.

10. The method of claim 7, wherein processing the video data includes masking the dynamic content.

11. A method for building a state diagram for later navigating to specified states of a mobile device, comprising:
defining a root node;
finding a first node with missing outgoing links;
navigating to a state corresponding to the first node on the mobile device; and
sending a navigation event to the mobile device.

12. The method of claim 11, further comprising storing the navigation event in a state diagram.

13. The method of claim 11, further comprising determining a shortest path from a current state to a desired state in the state diagram.

14. The method of claim 13, further comprising sending navigation events corresponding to the shortest path to the mobile device.

15. The method of claim 13, wherein the shortest path is determined by
identifying the current state and the desired state of the mobile device;
determining the depth of the desired state from the root node; and
adding a configured path from the current state to the root node.

16. An apparatus for identifying a current state of a mobile device for recording interactions with the mobile device, comprising:
an interface configured for connecting to the mobile device;
a processor communicatively coupled to the interface and programmed for recording the interactions with the mobile device by
receiving a current state from the mobile device,
separating a transitional sequence between states and a stable state from the current state, and
masking dynamic content from the stable state to identify the canonical samples that represent the stable state.

17. The apparatus of claim 16, wherein the processor is further programmed for detecting a stable loop within the stable state.

18. The apparatus of claim 16, wherein the processor is further programmed for comparing the stable state with previously navigated states.

19. The apparatus of claim 16, wherein the processor is further programmed for creating a link from a previous state to the current state.

20. The apparatus of claim 16, wherein the processor is further programmed for determining the transitional sequence between states by comparing previously navigated states.

21. An apparatus for identifying a current state of a mobile device for recording interactions with the mobile device, comprising:
an interface configured for connecting to the mobile device;
a processor communicatively coupled to the interface and programmed for recording the interactions with the mobile device by
retrieving audio and video data from the mobile device,
filtering dynamic content,
processing the video data for fast comparison, and
detecting loops in the video data.

22. The apparatus of claim 21, wherein the processor is further programmed for processing the video data by masking the dynamic content.

23. An apparatus for building a state diagram for later navigating to specified states of a mobile device, comprising:
an interface configured for connecting to the mobile device;
a processor communicatively coupled to the interface and programmed for determining the navigation paths of the mobile device by
defining a root node,
finding a first node with missing outgoing links,
navigating to a state corresponding to the first node on the mobile device, and
sending a navigation event to the mobile device.

24. The apparatus of claim 23, wherein the processor is further programmed for determining a shortest path from a current state to a desired state in the mobile device.

25. The method of claim 24, wherein the shortest path is determined by
identifying the current state and the desired state of the mobile device;
determining the depth of the desired state from the root node; and
adding a configured path from the current state to the root node.

26. A computer-readable medium comprising program code for identifying a current state of a mobile device for recording interactions with the mobile device, the program code for causing performance of a method comprising:
receiving a current state from the mobile device,
separating a transitional sequence between states and a stable state from the current state, and
masking dynamic content from the stable state to identify the canonical samples that represent the stable state.

27. The computer-readable medium of claim 26, the program code further for causing performance of the method comprising detecting a stable loop within the stable state.

28. The computer-readable medium of claim 26, the program code further for causing performance of the method comprising comparing the stable state with previously navigated states.

29. The computer-readable medium of claim 26, the program code further for causing performance of the method comprising creating a link from a previous state to the current state.

30. The computer-readable medium of claim 26, the program code further for causing performance of the method comprising determining the transitional sequence between states by comparing previously navigated states.

31. A computer-readable medium comprising program code for identifying a current state of a mobile device for recording interactions with the mobile device, the program code for causing performance of a method comprising:
retrieving audio and video data from the mobile device,
filtering dynamic content,
processing the video data for fast comparison, and
detecting loops in the video data.

32. The computer-readable medium of claim 31, the program code further for causing performance of the method comprising processing the video data by masking the dynamic content.

33. A computer-readable medium comprising program code for building a state diagram for later navigating to specified states of a mobile device, the program code for causing performance of a method comprising:
defining a root node,
finding a first node with missing outgoing links,
navigating to a state corresponding to the first node on the mobile device, and
sending a navigation event to the mobile device.

34. The computer-readable medium of claim 33, the program code further for causing performance of the method comprising determining a shortest path from a current state to a desired state in the mobile device.

35. The computer-readable medium of claim 34, the program code further for causing performance of the method comprising determining the shortest path by
identifying the current state and the desired state of the mobile device;
determining the depth of the desired state from the root node; and
adding a configured path from the current state to the root node.

36. An apparatus for controlling a mobile device and recording interactions between the apparatus and the mobile device for subsequent simulation in a virtual environment, comprising:
a device interface to connect to the mobile device and control a navigation of the mobile device;
an automated crawler to determine an unmapped state of the mobile device; and
a state listener to record a control and a response from the mobile device and determine if the response was previously recorded.
